(19) United States
(12) Patent Application Publication
(10) Pub. No.: US 2013/0152156 A1
(43) Pub. Date: Jun. 13, 2013

(54) VPN SUPPORT IN A LARGE FIREWALL CLUSTER

(71) Applicants: Tylor Allison, Stillwater, MN (US); Michael J. Karels, Eden Prairie, MN (US)

(72) Inventors: Tylor Allison, Stillwater, MN (US); Michael J. Karels, Eden Prairie, MN (US)

(73) Assignee: MCAFEE, INC., SANTA CLARA, CA (US)

(21) Appl. No.: 13/323,816

(22) Filed: Dec. 12, 2011

(51) Int. Cl. G06F 21/00

(52) U.S. Cl. 726/1; 726/11

(57) ABSTRACT

A firewall cluster comprises three or more firewall processing nodes, at least one of which is operable to establish a Virtual Private Network (VPN) network connection. A node is further operable to share VPN state information with two or more receiving nodes by sending broadcast message to the two or more nodes.

Shared VPN state information in various embodiments includes encryption keys for a VPN session or security policy information identifying what data should encrypted. Shared VPN state information is used to route VPN connections traffic to a primary node, or to provide for reassignment of VPN processing in the firewall for load balancing or failover.

### FIELD OF THE INVENTION

The invention relates generally to firewall operation, and more specifically in one embodiment to VPN support in a large firewall cluster.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending or by performing other computer-to-computer communication.

But, because the size of the Internet is so large and Internet users are so diverse in their interests, it is not uncommon for malicious users or pranksters to attempt to communicate with other users' computers in a manner that poses a danger to the other users. For example, a hacker may attempt to log in to a corporate computer to steal, delete, or change information. Computer viruses or Trojan horse programs may be distributed to other computers, or unknowingly downloaded or executed by large numbers of computer users. Further, computer users within an organization such as a corporation may on occasion attempt to perform unauthorized network communications, such as running file sharing programs or transmitting corporate secrets from within the corporation's network to the Internet.

For these and other reasons, many corporations, institutions, and even home users use a network firewall or similar device between their local network and the Internet. The firewall is typically a computerized network device that inspects network traffic that passes through it, permitting passage of desired network traffic based on a set of rules.

Firewalls perform their filtering functions by observing communication packets, such as TCP/IP or other network protocol packets, and examining characteristics such as the source and destination network addresses, what ports are being used, and the state or history of the connection. Some firewalls also examine packets traveling to or from a particular application, or act as a proxy device by processing and forwarding selected network requests between a protected user and external networked computers.

The firewall typically controls the flow of network information by monitoring connections between various ports, sockets, and protocols, such as by examining the network traffic in a firewall. Rules based on socket, port, application, and other information are used to selectively filter or pass data, and to log network activity. Firewall rules are typically configured to identify certain types of network traffic that are to be prohibited or that should have certain other restrictions applied, such as blocking traffic on ports known to be used for file sharing programs while virus scanning any received over a traditional FTP port, blocking certain applications or users from performing some tasks while allowing others to perform such tasks, and blocking traffic based on known attack patterns such as repeated queries to different ports from a common IP address. Firewalls can also be configured to permit certain types of traffic, such as to allow encrypted traffic so that a remote system can communicate with a VPN or Virtual Private Network behind the firewall.

But, the ability of a firewall to manage such connections when distributed across multiple computer systems is limited in that knowledge of a connection is typically stored only in the system handling the connection. Improved firewall distribution in a cluster is therefore desired.

### SUMMARY

In one example embodiment, a firewall cluster comprises three or more firewall processing nodes, at least one of which is operable to establish a Virtual Private Network (VPN) network connection. A node is further operable to share VPN state information with two or more receiving nodes by sending broadcast message to the two or more nodes.

Shared VPN state information in various embodiments includes encryption keys for a VPN session or security policy information identifying what data should encrypted. Shared VPN state information is used to route VPN connections traffic to a primary node, or to provide for reassignment of VPN processing in the firewall for load balancing or failover.

### BRIEF DESCRIPTION OF THE FIGURES

FIG. 1 shows an example network including a firewall, as may be used to practice some embodiments of the invention.

FIG. 2 shows an example network including a firewall cluster comprising multiple firewall nodes, consistent with an example embodiment of the invention.

FIG. 3 shows an example network including a distributed firewall having VPN support, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

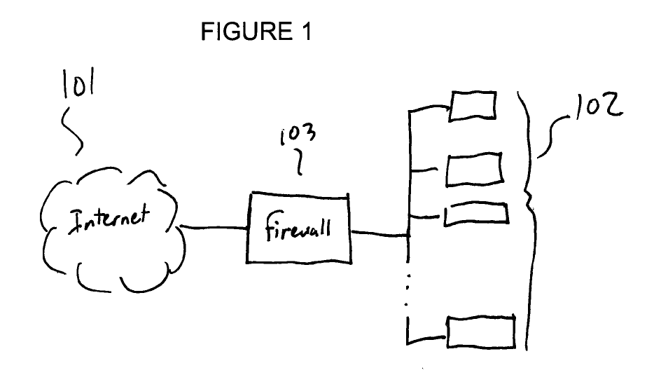

FIG. 1 illustrates a typical computer network environment, including a public network such as the Internet at 101, a private network 102, and a computer network device operable to provide firewall and intrusion protection functions shown at 103. In this particular example, the computer network device 103 is positioned between the Internet and the private network, and regulates the flow of traffic between the private network and the public network.

The network device 103 is in various embodiments a firewall device, and intrusion protection device, or functions as both. A firewall device or module within the network device provides various network flow control functions, such as inspecting network packets and dropping or rejecting network packets that meet a set of firewall filtering rules. As described previously, firewalls typically perform their filtering functions by observing communication packets, such as TCP/IP other network protocol packets, and examining characteristics such as the source and destination network addresses, what ports are being used, and the state or history of the connection. Some fire-walls also examine packets to determine what application has established the connection, or act as a proxy device by processing, and forwarding selected network requests between a protected user and external networked computers. Firewalls often use “signatures” or other characteristics of undesired traffic to detect and block traffic that is deemed harmful or that is otherwise undesired.

Firewalls typically use sets of rules to filter traffic, such that what happens with any particular element of network data is dependent on how the rule set applies to that particular data. For example a rule blocking all traffic to port 6346 will block incoming traffic bound for that port on a server within the protected network, but will not block other data going to the same server on a different port number. Similarly, a rule blocking traffic originating from a file sharing program such as Shareaza will use patterns in the traffic to block Shareaza traffic on port 6346, but allow other traffic on port 6346.

But, in an environment where a firewall is implemented as a system distributed across multiple computers or nodes, such as in a large or complex system, the ability of multiple nodes to share a connection is limited by each node's information regarding the connection, such as socket information, application information, user information, and the like regarding the connection. Some embodiments of the invention therefore share information, such as Virtual Private Network or VPN connection data, with other nodes in the firewall. Because only one node handles each connection at one time, sharing information between nodes provides the cluster the ability to load balance by moving connection responsibility between nodes, to manage failure of a node in the cluster by moving its connections to another node, and to perform other such functions.

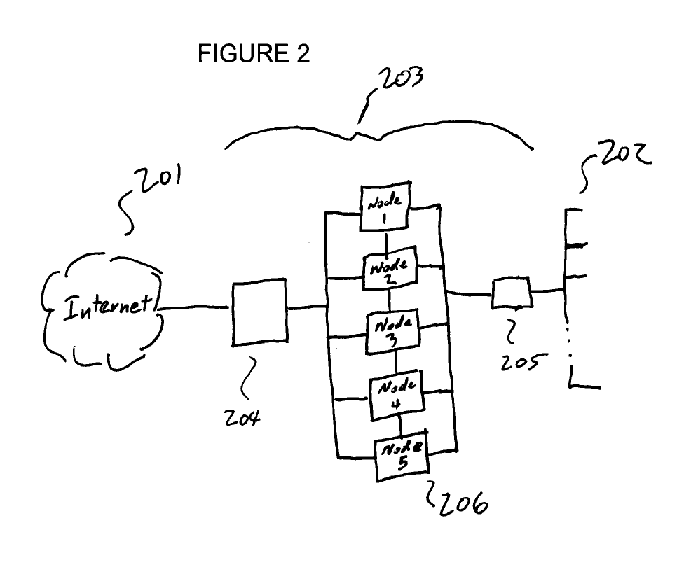

In one such example, a firewall or intrusion protection system is implemented as a cluster or connected group of nodes that share processing traffic flowing through the firewall. FIG. 2 shows a network with a distributed firewall, as may be used to practice some embodiments of the invention. Here, a network such as the Internet 201 is coupled to an internal network 202 by a firewall, 203. The firewall 203 comprises an incoming traffic module 204 and an outgoing traffic module 205 that can perform functions such as load balancing and other firewall management functions. The firewall or intrusion protection rules are applied in firewall nodes 206, which are connected to one another by network connections as shown.

Here the five nodes shown each comprise a separate computer system running an instance of firewall or related software, operable to apply rules to traffic to selectively permit or block traffic flowing between the Internet 201 and the internal network 202. In an alternate embodiment, some nodes such as nodes 1, 2, and 3 execute a firewall application, while other nodes such as 4 and 5 execute an intrusion protection system (IPS) application. The nodes 204 and 205 are responsible for performing functions such as load balancing traffic routed to the firewall nodes 206, ensuring that the nodes are able to work together efficiently to provide higher throughput capability than a single node.

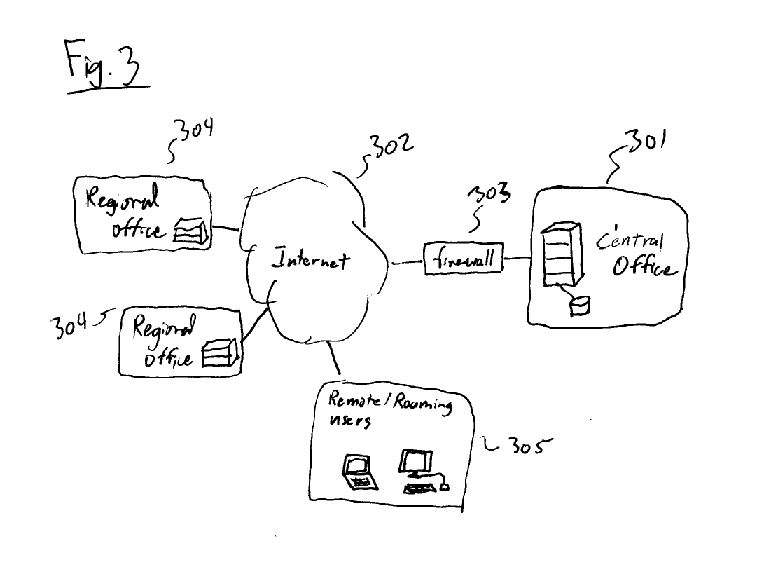

When a computer wishes to communicate with a Virtual Private Network or VPN, it typically uses an encrypted connection to ensure that the communicated data remains private. An example of such a VPN configuration is shown in FIG. 3, as may be used to practice some embodiments of the invention. Here, a central office 301 has a corporate computer system, which is connected to the Internet 302 via a firewall 303. The firewall prevents unauthorized access to the home office's computer servers and corporate data, while allowing desired data such as email and web traffic to flow through.

In this example, the home office has also configured a Virtual Private Network or VPN that allows computer systems at regional offices 304 and mobile or home office users at 305 to access the corporate network through the firewall while preserving data security. This is achieved by authenticating the remote user, such as the regional office 304 or remote users, to the home office, and establishing a secure or encrypted connection over which data can be exchanged. Authentication can use passwords, digital certificates, biometrics, secure token codes, or other such mechanisms to ensure that the remote user attempting to connect to the home office is a known and authorized party. Encryption of the established link, such as IPSec, SSL/TLS, or other encryption mechanisms are typically employed to ensure that the various systems on the Internet 302 through which traffic may pass cannot intercept and read the company's confidential information.

But, because the firewall 303 is configured to control traffic between the home office and external users, it is typically configured to manage or be aware of VPN traffic. For example, the firewall may permit access to a VPN server to which a remote user authenticates, and then permit only certain TCP destination port and IP protocol IDs that match expected VPN traffic. For example, some VPN servers uses TCP destination port 1723 to receive VPN traffic, and IP protocol ID 47 to identify VPN packets, and the firewall is configured to allow this traffic to the VPN server.

Other firewall examples include firewall monitoring of VPN data to ensure that undesirable data is not brought into the home office 301 from remote users, such as a virus being transferred from a home computer to the home office network computers. This involves inspecting incoming decrypted packets in the firewall, and encrypting any outgoing VPN traffic before being sent to a remote location. In such examples, the firewall performs encryption functions such as by using IPSec encryption keys on the data, in coordination with the VPN server. In some examples the firewall includes a VPN server, simplifying interaction between the VPN and firewall. In one such example, the firewall shares the VPN server's encryption keys and can decrypt and inspect traffic flowing through the firewall before forwarding the encrypted traffic to a remote computer. In another firewall example, encrypted communication is passed unfiltered to a specific port on the central office's separate VPN server using technologies such as IPSec, or is handled via proxy in the firewall via technologies such as SSL.

In firewall example such as the distributed firewall of FIG. 2, managing a firewall having an integrated VPN can be challenging in that VPN session information will be generated local to a specific node 206 handling the connection. Should the node fail, or should the connection be transferred to another node such as for load balancing, the new node will desirably have connection state information regarding the connection such as IPSec keys and security policy information indicating what packets should be encrypted.

For these reasons, various embodiments of the invention include VPN state sharing across nodes in a distributed firewall, such as by sending state update information to the other nodes in the firewall. In one such embodiment, the state is sent from the primary node or the node originating the VPN connection to each of the other nodes in the firewall, and an acknowledgment is received in the originating node or in the primary node.

In other embodiments, such a system of send/acknowledge messages is replaced by a multicast or broadcast system of state sharing, in which the state is distributed to each node in the firewall cluster. In a more detailed example, no acknowledgment is sent from the receiving nodes in the firewall cluster, but the primary node distributes all state updates and numbers or otherwise orders the updates, so that if a node misses an update it can be identified and resolved.

For example, if a new IPSec connection is initiated in distributed firewall 206 of FIG. 2, the primary node negotiates and establishes the session before the connection is handed off to another node. The primary node further sends state information regarding the connection to each of the other nodes in a broadcast or multicast message, along with a serialized message tag such as a message number.

The receiving nodes then receive the message and compare the message number to the expected next message number to ensure that all messages have been received. For example, a node that has received messages 1, 2, and 3, and then receives message 6, will know that it has missed messages 4 and 5. The receiving node can then request these messages be re-sent from the primary node, and have a high probability that all messages have been received.

In a more detailed example, a window or range such as 32 message numbers is used to number messages in around-robin fashion, such that the primary node buffers and numbers messages numbered 1-32 before restarting with message 1 again. A receiving node therefore has a window of 32 received messages in which to request and receive any missing messages before the primary node will overwrite the buffer storing sent messages with a new message, after which the missing message will be resolved by re-sending the entire connection state database.

Such a method of distributing connection state information for distributed connections such as an IPSec VPN connection reduce the number of messages that would need to be sent between nodes from a node-to-node receive/acknowledge state distribution method, especially in environments where IPSec or other VPN session keys are updated several times per hour and many VPN sessions are running on the same firewall.

The state information shared with the distributed firewall nodes also includes IPSec policy updates in some embodiments, so that any secondary node handling IPSec traffic knows that the traffic is to be encrypted as part of an IPSec session before being sent to the external network. In further examples, this IPSec policy update includes an identifier of the node handling the specific IPSec connection, or simply designates that the connection is an IPSec connection and the node knows that all IPSec traffic is handled by a designated node such as the primary node.

In a more complex example a TCP session or other connection can be broken in two, such as where a load balancer on the server or central office side of the firewall reassigns part of a connection using certain protocols for load balancing. For example, a user may initiate a TCP session with distributed firewall node 1 while the FTP connection is handled on the central office side of the firewall by keeping a control session on node 1 but the data session on node 2. Here, node 1 publishes primary connection information to the other nodes in the firewall using a method such as those described above, so the secondary connection to node 2 is recognized and passed back to the external user.

In a more detailed example, the secondary node 2 handling the data connection forwards all traffic it receives in the session back to node 1 so that the FTP proxy on node 1 can manage the connection back to the external user in one example, so that the node handling the primary connection is the single node that exchanges FTP session data with the external user. This is done so that an FTP proxy managed by node 1 can process both the control and the data sessions in the FTP connection, despite the connection's sessions being split among nodes 1 and 2 on the central office side of the firewall.

These examples illustrate how sharing state information regarding a Virtual Private Network or VPN in a distributed firewall cluster can be used to provide for improved firewall performance, enabling transferring of VPN responsibility between nodes such as for node balancing or failover. It also illustrates how a multicast security policy update with message serialization can be used to reduce the demand placed upon node-to-node connections in the distributed firewall, while ensuring that all nodes have up-to-date copies of the security policy.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein, it is intended that this invention be limited only by the claims, and the full scope of equivalents thereof.

1. A method of operating a firewall cluster, comprising:
establishing a Virtual Private Network (VPN) network connection in a firewall cluster having three or more firewall processing nodes; and
sharing VPN state information with two or more receiving nodes by sending broadcast message to the two or more nodes

2. The method of operating a firewall cluster of claim 1, further comprising serializing the broadcast message such that the two or more receiving nodes can identify missing received messages.

3. The method of operating a firewall cluster of claim 1, wherein the VPN state information comprises encryption keys.

4. The method of operating a firewall cluster of claim 1, wherein the VPN state information comprises security policy information identifying what data should encrypted.

5. The method of operating a firewall cluster of claim 1, further comprising using VPN state information to route VPN connections traffic to a primary node.

6. The method of operating a firewall cluster of claim 5, wherein the primary node shares VPN state information with other nodes in the firewall cluster.

7. The method of operating a firewall cluster of claim 1, wherein the distributed firewall uses VPN state information to assign a new node to handle VPN connections to provide load balancing or failover.

8. A distributed firewall cluster, comprising:
three or more firewall processing nodes, at least one of which is operable to establish a Virtual Private Network (VPN) network connection, at least one of which is further operable to share VPN state information with two or more receiving nodes by sending broadcast message to the two or more nodes.

9. The distributed firewall cluster of claim 8, wherein the broadcast message is serialized such that the two or more receiving nodes can identify missing received messages.

10. The distributed firewall cluster of claim 8, wherein the VPN state information comprises encryption keys.

11. The distributed firewall cluster of claim 8, wherein the VPN state information comprises security policy information identifying what data should encrypted.

12. The distributed firewall cluster of claim 8, wherein at least one firewall processing node is further operable to use VPN state information to route VPN connections traffic to a primary node.

13. The distributed firewall cluster of claim 12, the primary node operable to share VPN state information with other nodes in the firewall cluster.

14. The distributed firewall cluster of claim 8, wherein the distributed firewall uses VPN state information to assign a new node to handle VPN connections to provide load balancing or failover.

15. A machine-readable article of manufacture with instructions stored thereon, the instructions when executed operable to cause a computerized system to:
establish a Virtual Private Network (VPN) network connection in a firewall cluster having three or more firewall processing nodes; and
share VPN state information with two or more receiving nodes by sending broadcast message to the two or more nodes

16. The machine-readable article of manufacture of claim 15, the instructions when executed operable to cause a computerized system to serialize the broadcast message such that the two or more receiving nodes can identify missing received messages.

17. The machine-readable article of manufacture of claim 15, wherein the VPN state information comprises at least one of encryption keys or security policy information identifying what data should encrypted.

18. The machine-readable article of manufacture of claim 15, the instructions when executed operable to cause a computerized system to use VPN state information to route VPN connections traffic to a primary node.

19. The machine-readable article of manufacture of claim 18, wherein the primary node shares VPN state information with other nodes in the firewall cluster.

20. The machine-readable article of manufacture of claim 15, wherein the distributed firewall uses VPN state information to assign anew node to handle VPN connections to provide load balancing or failover.
